(19) United States
(12) Patent Application Publication
(10) Pub. No.: US 2018/0039957 A1
(43) Pub. Date: Feb. 8, 2018

(54) SYSTEM FOR ASSISTING WITH THE PRODUCTION OR REPAIR OF A TURBOMACHINE

(71) Applicant: Safran Aircraft Engines, Paris (FR)

(72) Inventors: Clément Paul Claude Guinot, Thorigny Sur Marne (FR); Brice Yvan Cédric Charpentier, Les Ulis (FR); Lydie Martine Chevalier, Saint Just (FR); Laurent Yanick Maurice Hervault, Montigny Lencoup (FR)

(21) Appl. No.: 15/550,570

(22) PCT Filed: Feb. 9, 2016
(86) PCT No.: PCT/FR2016/050280

§ 371 Date: Aug. 11, 2017

(30) Foreign Application Priority Data
Feb. 12, 2015 (FR) 15 51160

(51) Int. Cl. G06Q 10/00; G06F 3/01; F02C 7/00; G05B 17/02

(52) U.S. Cl. CPC G06Q 10/20; G05B 17/02; G06F 3/01; F02C 7/00

(57) ABSTRACT

The invention relates to a method for assisting with the production or repair of a turbomachine. The method comprises a step (91) of displaying first production or repair information about the turbomachine on a portable display device. The method comprises a step (92) of blocking the display of second production or repair information on the portable display device at least as long as there has been no detection that a user has, in response to the first information, performed a predetermined action (94) of validating (81) and/or of invalidating (82) the condition of the turbomachine.

### TECHNICAL DOMAIN

The invention relates to the general technical domain of aircraft turbomachines. More precisely, the invention relates to system for assisting with the production or repair of the turbomachine.

### STATE OF PRIOR ART

A known system for assisting with the production or repair of a turbomachine comprises paper sheets containing a list of points to be verified or performed by the user. These sheets are accompanied by illustrations.

The user, in other words a person qualified to assembly or repair the turbomachine, can make a mistake when referring to the sheets or the illustrations.

In particular, information available to the user might not be up to date. It is also possible that the user might forget some points to be checked present on one of the sheets or illustrations.

Finally, production or repair of the turbomachine sometimes continues by mistake even when the user has detected an anomaly.

Therefore there is a need to improve known systems for assisting with the production or repair of a turbomachine so as to limit risks of human error during assembly and/or repair of a turbine machine.

### PRESENTATION OF THE INVENTION

The invention is aimed at least partially solving problems encountered in solutions according to prior art.

To achieve this purpose the invention relates to a method for assisting with the production or repair of a turbomachine, comprising:

a step of displaying first production or repair information for the turbomachine on a portable display device,

a step of blocking the display of second production or repair information on the portable display device, at least until a predetermined action to validate and/or invalidate the condition of the turbomachine performed by a user in response to the first information has not been detected.

The method of assisting with the production or repair of the turbomachine, and the assistance system to implement this method, can limit human errors during turbomachine production or repair operations.

Production or repair information displayed by the display device is indeed appropriate information specific to the user, his assembly or repair station, and to the specific type of turbomachine on which he is working. This precise type of turbomachine is identified by its individual serial number and the specific technical definition of the turbomachine. This information is updated automatically and therefore cannot be incorrect.

Furthermore, the risk of accidentally shipping a turbomachine with an anomaly when an invalidation action performed by the user has been detected is reduced.

Moreover, computerisation of the system for assisting with production and repair enables better monitoring of anomalies detected during the production or repair of turbomachines.

The portable device can more easily be transported close to the turbomachine to be assembled or repaired than a file of sheets or illustrations about the turbomachine. In particular, the portable display device is not as heavy and large as folders used in the past Computerisation also guarantees faster and more reliable distribution and updates.

Optionally, the invention may comprise one or several of the following features, possibly but not necessary combined with each other.

Advantageously, the predetermined action comprises the specification of the condition of the turbomachine in the form of an audio and/or visual comment.

According to one particular embodiment, the predetermined action comprises taking a picture of the turbomachine and/or writing a comment on the condition of the turbomachine.

According to one advantageous embodiment, the first information and/or the second information comprises at least information about a visual inspection of the turbomachine to be made by the user.

Preferably, the first and/or the second information is selected by the user from among a predetermined set of production or repair information for the turbomachine.

For example, the display of this predetermined set of information may be in the form of a list, a table or a series of miniaturised illustrations.

According to one advantageous embodiment, the method comprises a step of transmission of an alert to a remote computer device when a predetermined invalidation action is detected.

The invention also relates to a system for assisting with the production or repair of a turbomachine comprising a computer unit and a portable display device.

The computer unit contains turbomachine production or repair information. The computer unit preferably comprises at least one computer.

The portable display device is configured to display the first turbomachine production or repair information from the computer unit. The display device is configured to be connected to the remote computer unit.

The assistance system also comprises a control unit configured to block display of the second turbomachine production or repair information, at least until the assistance system has detected a predetermined validation and/or invalidation action by a user of the condition of the turbomachine in response to the first information.

According to one particular embodiment, the control unit is configured to authorise the display of second information,

when a predetermined invalidation action has been detected and the condition of the turbomachine has been specified in the form of an audio and/or visual comment.

Advantageously, the control unit is configured to unblock the display of second information when a validation action has been detected.

According on one particular embodiment, the control unit is configured to block the display of second information when a predetermined invalidation has been detected, and as long as the control unit has not received an authorisation to unblock the display of the second information.

According to one advantageous embodiment, the assistance system comprises means for authenticating the user and/or the turbomachine.

Preferably, the assistance system is configured to display a three-dimensional model of the turbomachine on the display device, the first and/or second information comprising the display of at least part of the model.

According to one special feature of the embodiment, the assistance system is configured to save the name of the user and associate it with the predetermined action.

Furthermore, the assistance system is preferably configured to also save the date and the time, associating them with the predetermined action.

In particular, the user sanctions the predetermined action by adding his signature.

According to another advantageous embodiment, the display device comprises a recording unit configured to save a specification of the condition of the turbomachine in the form of an audio and/or video comment during the predetermined action.

The display device preferably comprises a camera, a module for selection of a predetermined specification and/or a write module to input a comment.

### BRIEF DESCRIPTION OF THE DRAWINGS

This invention will be better understood after reading the description of example embodiments, given purely for information and in no way limitative, with reference to the appended drawings on which:

FIG. 1 is a partial diagrammatic representation of a system for assisting with production or repair of a turbomachine, according to one preferred embodiment when it is used by an operator;

FIG. 2 functionally and diagrammatically represents the control unit of the system shown in FIG. 1;

FIG. 3 functionally and diagrammatically represents the portable display device of the assistance system shown in FIG. 1;

FIG. 4 diagrammatically illustrates implementation of a method for assisting with production or repair of a turbomachine;

FIG. 5 illustrates a first embodiment of the implementation of a particular variant of the method illustrated generally in FIG. 4 showing more details, for the visual inspection of a turbomachine;

FIG. 6 illustrates a second embodiment of the implementation of a particular variant of the method illustrated generally in FIG. 4 showing more details, for the production of a turbomachine;

### DETAILED PRESENTATION OF PARTICULAR EMBODIMENTS

Identical, similar or equivalent parts of the different figures have the same numeric references to facilitate the comparison between different figures.

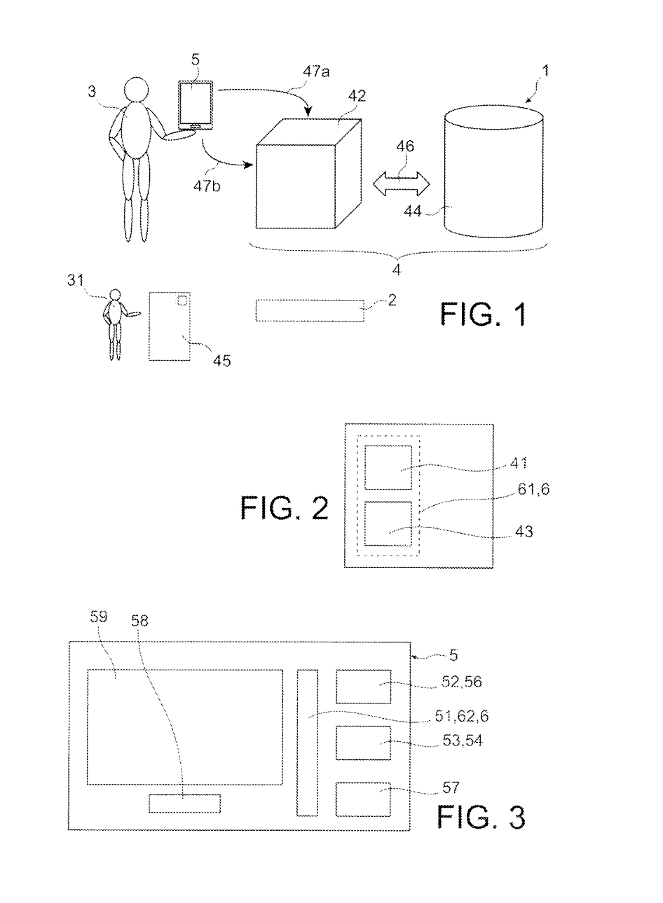

FIG. 1 represents a method 1 for assisting with the production or repair of an aircraft turbomachine 2. The system 1 will assist the work of a user 3 who is a person working on an assembly or repair line of the turbomachine 2.

The system for assisting with the production or repair comprises principally a computer unit 4 and a portable display device 5. The computer unit 4 comprises a computer system 42 and a database 44.

With reference to FIG. 2, the computer system 42 comprises a control centre 41 and a memory 43. The control centre 41 comprises at least one processor. In particular, the memory 43 is a reprogrammable temporary memory.

The control centre 41 and the memory 43 form a first control unit 61 configured to authorise or prevent transmission of information between the database 44 and the portable display device 5.

The computer system 42 communicates in a classic manner with the database 44 in both directions through the control centre 41, that is represented by the double arrow 46.

The database 44 contains production or repair information for the turbomachine 2 accessible from a distance through a wireless link 47a, 47b through the computer system 42 by the portable display device 5.

With reference to FIGS. 1 and 3, the portable display device 5 may for example be in the form of a tablet or smartphone.

It is portable, in other words it can be carried by the user close to the turbomachine 2 to be manufactured or repaired.

The portable display device 5 is preferably intended to allow the user 3 to have at least partially free hands when he is working on the production or repair of the turbomachine 2 and is holding the display device 5.

The portable display device 5 comprises a control device 51, a memory 58 connected to the control device 51, and a screen 59.

The portable display device 5 also comprises a write module 52, a selection module 56, a still camera 53, a movie camera 54 and a microphone 57.

The control device 51 comprises at least one processor that is able to communicate with the control centre 41 of the computer system 42. The control device 51 also acts as a second control unit 62 configured to authorise or block the display of production or repair information on the screen 59.

The screen 59 displays for the attention of the user 3 production or repair information 7 for the turbomachine 2, temporarily stored in the memory 58, when ordered by the control device 51.

The memory 58 acts as a recording unit 58 for an audio and/or visual comment to be made by the user 3. The memory 58 records data from the microphone 57, the write module 52 or selection module 56, the still camera 53 or the movie camera 54.

The write module 52 is in the form of a physical or virtual keyboard and a word processor. The write module 52 is used by the user 3 to enter a comment.

The user uses the selection module 56 to make a choice among a predetermined list of production or repair information, a list of predetermined actions or predetermined problems encountered in relation with the turbomachine 2.

The write module 52 and the selection module 56 allows the user 3 to make a written comment about the condition of the turbomachine 2 currently being repaired or in maintenance.

The still camera 53 and the movie camera 54 take pictures to make a visual comment about the condition of the turbomachine 2 currently being produced or repaired.

The user can use the microphone 57 if he wishes to make an audio comment about the condition of the turbomachine 2.

The portable display device 5 is programmed to transmit an alert to a computer device 45 if the user 3 detects an anomaly. This alert about production or repair of the turbomachine 2 is transmitted to the attention of a qualified person 31, possibly through the control unit 61. The alert was recorded beforehand by the portable device 5. It is accompanied by the audio and/or visual comment made by the user 3.

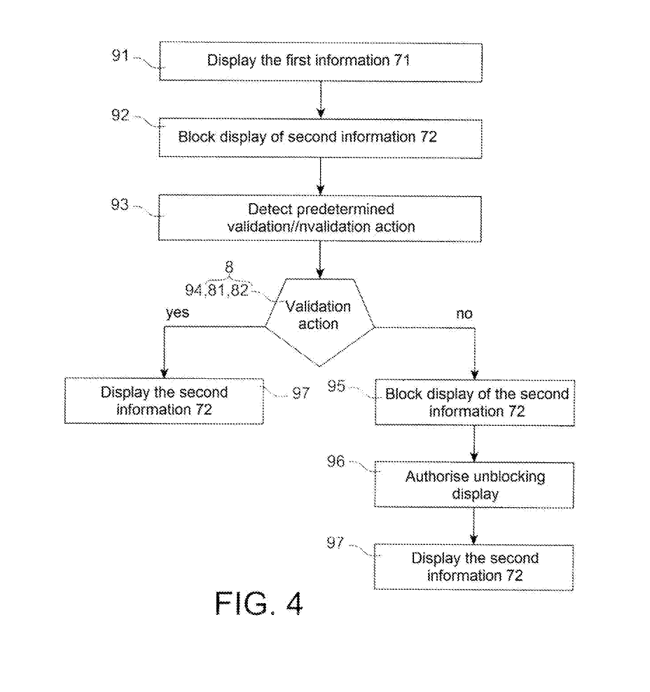

A general illustration of a production or repair assistance method implemented by the production or repair assistance system 1 is shown in FIG. 4.

Firstly, the screen 59 of the display device 5 displays first indications 71 for the production or repair of the turbomachine 2, to the attention of the user 3, during a step 91.

These first indications 71 will aid the user 3 to perform a production or repair operation on the turbomachine 2.

The term “production or repair” operation also comprises steps of checking the condition of the turbomachine during these operations. The term repair operation also covers a maintenance operation of the turbomachine 1.

As long as the user 3 has not performed a predetermined action 8 for validation 81 or invalidation 82 in a step 94, the display on the screen 59 of the second production or repair information displayed is blocked at step 92.

Display of the second information 72 can be blocked particularly at the control device 51 of the portable display device 5. This will be the case particularly when the second information 72 has been downloaded in the memory 58 from the computer unit 4.

As a variant or in addition, the display of the second information 72 can be blocked before these data are transmitted from the database 44 to the portable display device 5. In particular, the control centre 41 of the computer system 42 can prevent transmission of the second production or repair information 72 as long as the predetermined action 8 has not been detected.

In all cases, the display of the second production or repair information 72 is blocked by the control unit 6 that encompasses the first control unit 61 and the second control unit 62.

The second information 72 is also intended to assist the user 3 in performing a production or repair operation on the turbomachine 2, for example when he is occupied with a task following the task to which the first information 71 for production or repair of the turbomachine 2 is applicable.

As a variant, the second information 72 is additional to the first information 71, while remaining at least partially independent from the first information 71.

The first information 71 and the second information 72 is specific to the tasks assigned to the user 3 and to the turbomachine 2. The display device 5 can be used to select and to provide the user with up to date production or repair information.

When the display device 5 detects a predetermined action 8 of validation 81, the control unit 6 unblocks the display of the second information 72 on the screen 59 in step 97.

When the display device 5 detects, at step 93, a predetermined action 8 of invalidation 82, the control unit 6 continues to block the display of the second information 72 on the screen 59, firstly in step 95.

When an unblock authorisation is emitted in step 96, the display device displays the second information 72 in step 97.

Once the second information 72 is displayed on the screen, the user 3 can continue production or repair of the turbomachine 2.

The predetermined action 8 can be a validation action 81, in other words to signal that the situation of the turbomachine 2 during production or repair is satisfactory at this stage.

The predetermined action 8 can also be an invalidation action 82, in other words to signal that there is at least one an anomaly in the condition of the turbomachine at this stage of its production or repair.

The predetermined action 8 closes the work of the user 3 in a production or repair operation on the turbomachine 2. This operation may be a physical assembly or repair task, or an intellectual inspection task without any physical action by the user 3 on the turbomachine 2.

This operation is usually repeated during production or repair of the turbomachine 2.

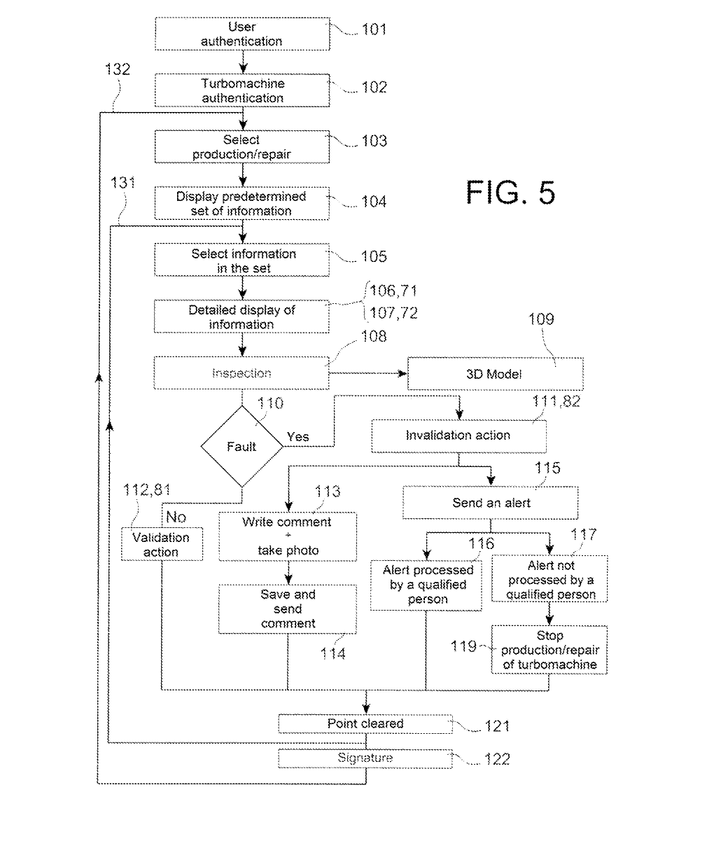

FIG. 5 represents a method of assisting with the production or repair, to assist the user 3 performing visual inspection operations of the condition of the turbomachine 2 during production or repair.

The assistance method begins with a step 101 to authenticate the user 3 using the display device 5. This authentication guarantees that the worker fulfils the requirements for the requested work.

The turbomachine 2 on which the user 3 works is subsequently authenticated during step 102.

More optionally, the user 3 can indicate the assembly or repair station on which he will do the work in step 103, so that the work done can be traced in an environment different from the specified environment.

The portable display device 5 then displays a set of production or repair information 7 that is specific to the turbomachine 2 and operations to be done by the user 3, in step 104.

The user 3 selects the first production or repair information in step 105 that is displayed in more detail on the screen 59 in step 106.

The user 3 then performs the visual inspection operation for which he is responsible in step 108, making use of the first information 71. If he considers it useful, he can use a three-dimensional model of the turbomachine 2 on his display device 5 in step 109.

If the user 3 does not find any anomaly in the form of a defect in the production or repair of the turbomachine at this stage in step 110, he validates the visual inspection in step 112 by a predetermined validation action 81 on the display device 5.

If the user 3 finds an anomaly in the form of a defect in the production or repair of the turbomachine at this stage in step 110, he invalidates the visual inspection in step 111 by a predetermined invalidation action 82.

The predetermined invalidation action 82 leads to the user 3 to writing a comment on the display device 5, and the user takes a photo to illustrate the detected anomaly, in step 113.

This written and illustrated comment is recorded in step 114. It is transmitted at the same time as an alert to the computer device 45 of the qualified person 31 in step 115.

The qualified person 31 can process the alert in step 116 and issue an authorisation to unblock the display of production or repair information 7 related to the next operation to be done by the user 3 on the turbomachine 2. In practice, this qualified person 31 is an engineer or a technician.

In step 117, the qualified person 31 has not processed the alert and the display of second information 72 for this turbomachine 2 is blocked. The user 3 cannot continue his work on this turbomachine 2, which limits risks of shipping a turbomachine 2 with one or more anomalies to a customer, as shown in step 119.

Obviously, the user 3 can possibly perform production or repair operations on another turbomachine, as long as the display of second information 72 related to the first turbomachine 2 is blocked.

The production or repair operation always terminates in step 121 by the signature of the user 3 subsequent to a predetermined action 8 of validation 81 or invalidation 82. In practice, this signature consists of recording the user's name by associated it with the predetermined action 8. The signature also engages the responsibility of the user 3.

At this moment, the display of second production or validation indications is unblocked.

The method can continue directly following the arrow 131 in step 107 with the display of second information 72.

As a variant, the method continues firstly by the selection of an assembly or repair station in step 103, along arrow 132. The portable display device 5 then displays a set of production or repair information 7 related to this station, in step 104. The second information 72 is then selected in step 105, then displayed in step 107.

In the case illustrated by the arrows 131 and 132, the user 3 selects new production or repair information 7 in a general manner and this second information 72 is displayed in detail, to help the user inspect the turbomachine 2 visually.

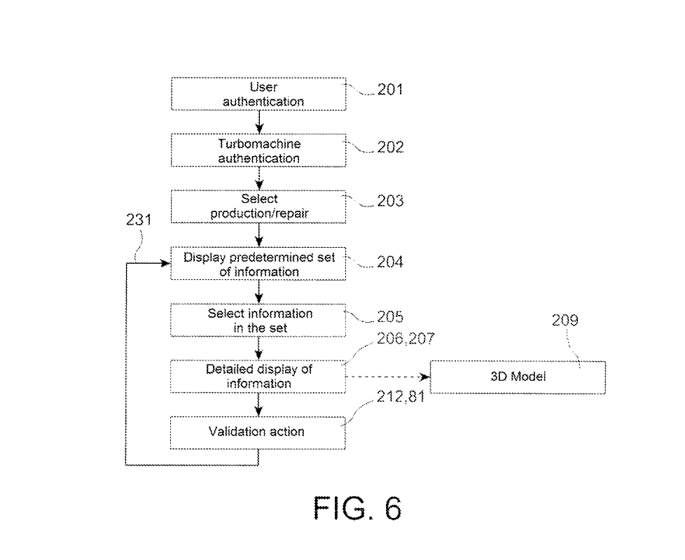

FIG. 6 illustrates a method of assisting with the production or repair, to assist the user 3 performing assembly operations of a turbomachine 2.

In a manner similar to the method described in FIG. 5, this method begins with authentication of the user and the turbomachine during steps 201 and 202. The user 3 then indicates in step 203 the assembly or repair station on which he is working.

A predetermined set of turbomachine production or repair information 7 is then displayed on the screen 59 of the portable display device 5 in step 204.

The user then selects the first production or repair information 71 for the assembly operation that he will perform, in step 205. This first information 71 is displayed on the display device, in step 206.

If he considers it useful, the user 3 can refer to a three-dimensional digital model of the turbomachine 2 during assembly, on his digital display device, in step 209.

Before terminating the assembly operation, the user 3 performs a predetermined validation action 81 on the display device 5, that unblocks the display of production or repair information 7 related to this turbomachine 2, in step 212.

The predetermined set of information 7 is then displayed again in step 204, as shown by the arrow 231.

The user 3 can then select second production or repair information 72 among the predetermined set of information 7 and display it in more detail in a step 207.

In general, the first information and the second information is the same as that found earlier in the files containing sheets and illustrations related to the turbomachine being manufactured or being repaired, according to known solutions.

The specification for a written or illustrated comment is only applicable after an invalidation action during progress with the methods illustrated on FIGS. 5 and 6.

Nevertheless it would be possible to organise matters such that a validation action can only lead to unblocking the display of the second assembly and repair information when the user has specified a comment.

A validation or invalidation action is detected firstly at the display device by a key or a button being pressed during the methods illustrated in FIGS. 5 and 6. This button or this key can be physical or virtual.

The data analysis following detection of the predetermined action may be made at the display device control element, at the computer system and/or external to the control unit.

The specification of a comment may form part of the validation or invalidation action.

As a variant, the specification of a comment can follow the predetermined action, taking place between the predetermined action and unblocking of the second production or repair information.

Specification of an audio and/or video comment by the user and detection of this comment by the display device can act as a predetermined validation or invalidation action.

In the methods illustrated in FIGS. 5 and 6, the unblocking authorisation after an invalidation action has been detected is issued by a qualified person.

In some cases, the second information may be information that the assembly or repair of the turbomachine is complete.

More generally, the second information can specify that the user's work on the turbomachine is complete, even if other operations related to production or repair still have to be performed on this turbomachine.

What is claimed is:

1-14. (canceled)

15. Method for assisting with the production or repair of a turbomachine comprising:
a step of displaying first production or repair information for the turbomachine on a portable display device,
a step of blocking the display of second production or repair information on the portable display device, at least until a predetermined action to validate and/or invalidate the condition of the turbomachine has not been detected, wherein the predetermined action is to be performed by a user in response to the first information.

16. The method according to the claim 15, wherein the predetermined action comprises the specification of the condition of the turbomachine in the form of an audio and/or a visual comment.

17. The method according to claim 16, wherein the predetermined action comprises taking a picture of the turbomachine and/or writing a comment on the condition of the turbomachine.

18. The method according to claim 15, wherein the first information and/or the second information comprises at least information about a visual inspection of the turbomachine to be made by the user.

19. The method according to claim 15, wherein the first and/or the second information is selected by the user from among a predetermined set of production or repair information for the turbomachine.

20. The method according to claim 15, comprising a step of transmission of an alert to a remote computer device when a predetermined action of invalidation is detected.

21. The method according to claim 15, comprising a step of unblocking the display of second information when a validation action has been detected.

22. The method according to claim 15, comprising a step of blocking the display of second information, when a predetermined action of invalidation has been detected, and as long as an authorisation has not been received to unblock the display of the second information.

23. The method according to claim 15, comprising displaying a three-dimensional model of the turbomachine on the display device, the first and/or second information comprising the display of at least part of the model.

24. The method according to claim 15, comprising a step of authenticating the user and/or the turbomachine.

25. The method according to claim 24, comprising saving the name of the user and associate it with the predetermined action.
